(19) United States
(12) Patent Application Publication
(10) Pub. No.: US 2013/0295575 A1
(43) Pub. Date: Nov. 7, 2013

(54) MICROPLATE AND MULTIWELL STRIP WITH DOUBLE RIMMED WELLS

(71) Applicants: Paul Day, Dorking (GB); Peter Collins, Shamley Green (GB); Thomas Lernbecher, Reigate (GB)

(72) Inventors: Paul Day, Dorking (GB); Peter Collins, Shamley Green (GB); Thomas Lernbecher, Reigate (GB)

(73) Assignee: 4TITUDE LIMITED, Wotton ,Surrey (GB)

(21) Appl. No.: 13/980,728

(22) PCT Filed: Jan. 20, 2012
(86) PCT No.: PCT/EP2012/050828

§ 371 Date: Jul. 24, 2013

(30) Foreign Application Priority Data
Jan. 20, 2011 (EP) 11151600.1

(51) Int. Cl. B01L 3/00

(52) U.S. Cl. CPC B01L 3/5085
USPC 435/6.12; 435/288.4; 435/7.92; 435/91.2

(57) ABSTRACT

The application discloses a microplate, wherein the openings of the wells for receiving reagents have a collar, wherein the collar comprises at least two upwardly extending rims, wherein the rims are radially separated by a gap (4), and wherein the rims are circumferentially closed. Furthermore, multiwall strips with such double rimmed wells are disclosed.

### FIELD OF THE INVENTION

The present invention relates to the field of disposables for laboratories, e.g. for chemical and biological laboratories. Particularly the invention provides a microplate and multiwell strip comprising double rimmed wells. Furthermore, the invention relates to the use of the microplates and multiwell strips as described herein in different methods and for storage purposes.

### BACKGROUND OF THE INVENTION

Various biological research and clinical diagnostic procedures and techniques require or are facilitated by an array of wells or tubes in which multiple samples are disposed for qualitative and quantitative assays or for sample storage and retrieval. Prior art devices that provide an array of wells or tubes capable of containing small sample volumes include microtitration plates that are commonly known as microplates.

It is often necessary or desirable to cover some or all of the wells in the plate. A variety of means have been used to achieve this, including caps, lids, mats, adhesive seals and heat seals. Lids and caps are used to firmly and completely seal the wells. However, closing a multiplicity of wells with lids or caps is laborious, time consuming and prone to cross-contamination. typical closure means and method of closure for containment devices with a multiplicity of wells such as microplates which rely upon a heat seal are disclosed in WO 94/12405. Further widely used closure means are adhesive seals, such as adhesive films. These films are applied on the top of the microplates and pressure is imposed to firmly seal the film with the rims of the wells. In order to increase the contact surface with the seal, the rims of the wells are often thickened. However, there is still a tremendous degree of evaporation and sample loss, particularly in methods where heat is applied to the microplate, seal and to the samples. During the use in polymerase chain reaction in a thermal cycler microplates and the seal are repeatedly heated and cooled resulting in growing and shrinking of the microplate and the adhesive film or heat seal. As the microplate and the seal often consist of different materials, the rate of growing and shrinking differs. This leads to great shear forces to the bonding between microplate and seal and to the formation of leaks. Thus, a great portion of the reaction mixture is lost during the reaction. Consequently, the concentrations of the reaction components vary during the reaction. This has negative effects on the specificity as well as the yield of the reaction.

One problem solved by the present invention is the provision of microplates which facilitates a complete and firm sealing of the wells by e.g. adhesive films or heat seals and thereby reduces the loss of liquid from the wells, e.g. by evaporation.

### DESCRIPTION OF THE INVENTION

The inventors have found that a microplate or multiwell strip comprising double rimmed wells can be completely and firmly sealed with adhesive films or a heat seal, i.e. the evaporation of liquids from the sealed microplate is reduced. Astonishingly, the provision of two rims increases the flexibility of the rims by narrowing each rim without reducing the strength of the bonding between the adhesive film or heat seal and the microplate. Interestingly it was observed that by such double rimmed wells it is possible to completely seal the well. The loss of liquid samples through evaporation is thereby reduced. It was unexpectedly found by the inventors that this effect is due to the higher flexibility of the rims, i.e. the rim is able to adapt to differing sizes of the microplate and the mat, adhesive film or heat seal during heating and/or cooling. This accommodates the shear forces that are applied to the bonding between the mat, adhesive film or heat seal and the rims of the wells by growing and shrinking of the plate during heating or cooling. Thereby the risk of leaks between the adhesive film or heat seal and the rims is greatly lowered.

Thus, the present invention relates to a microplate, wherein the openings of the wells for receiving reagents have a collar, wherein the collar comprises at least two upwardly extending rims (1; 2), wherein the rims (1; 2) are radially separated by a gap (4), and wherein the rims (1; 2) are circumferentially closed.

Microplates are used if a high amount of samples or reactions are to be processed. If fewer samples or reactions are processed one or more multiwell strips are employed in order to reduce material costs. In such case the sealing of a multiplicity of wells with lids or the like would also be laborious, time consuming and prone to cross-contamination. The use of mats, adhesive films or heat seals for the sealing of one or more multiwell strips is routine. Thus, the present invention also relates to a multiwell strip, wherein the openings of the wells for receiving reagents of the wells have a collar, wherein the collar comprises at least two upwardly extending rims (1;2), wherein the rims (1;2) are radially separated by a gap (4), and wherein the rims (1;2) are circumferentially closed.

### FIGURE LEGEND

Preferred embodiments of the present invention are depicted in the enclosed figures.

FIG. 1 shows a preferred embodiment of a well with an integral collar according to the present invention. (A) side view of preferred well with an integral collar which is downwardly extending and forms a cylinder (3). (B) Sectional view of a preferred well exemplifying the form of the at least two rims (1; 2) and the gap (4) as well as the radial outwardly extending circumferential rim at the upper edge (5) of the cylinder (3).

FIG. 2 shows a preferred embodiment of a microplate according to the present invention. (A) Top view of a preferred microplate. (B) Sectional view of the microplate. (C) Side view of a preferred microplate.

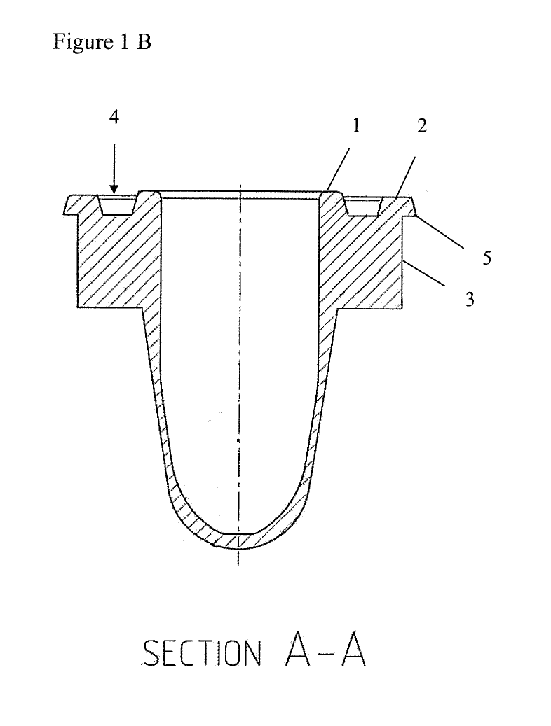

FIG. 3 shows a magnification of a cross sectional view of a preferred microplate. The wells are positively fitted into the frame and fixed by two radial outwardly extending circumferential rims at the upper and lower edge (5; 6).

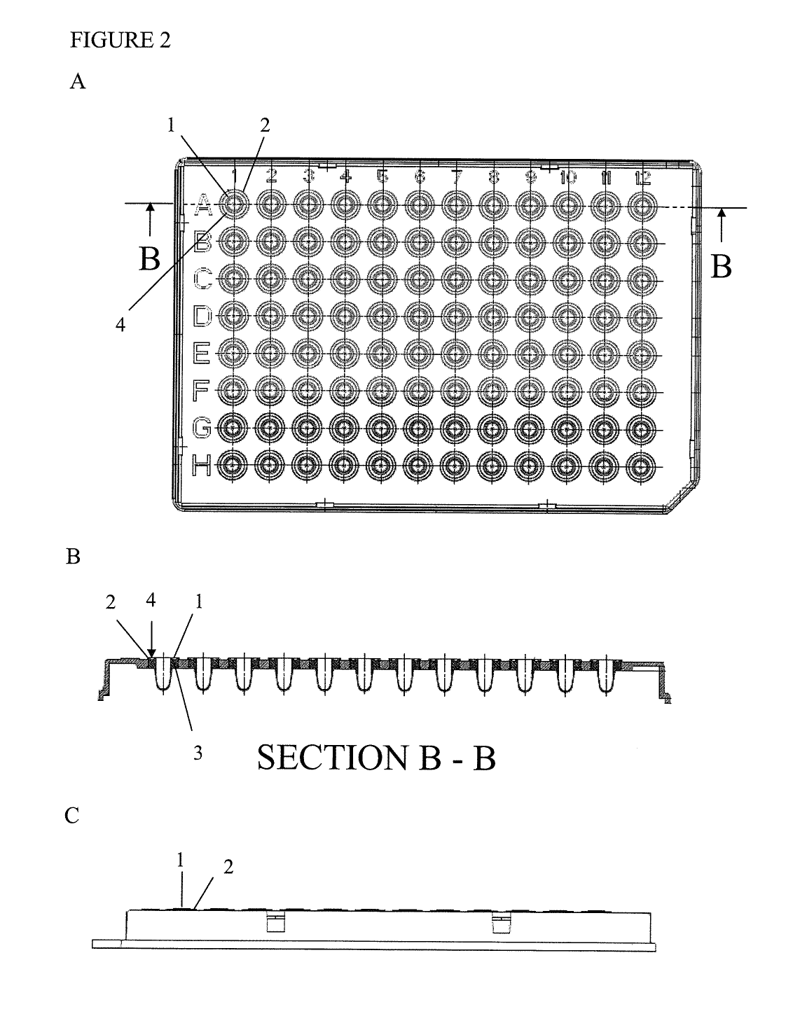

FIG. 4: A 1.5% agarose gel showing the product obtained from low volume PCR in both double rimmed small volume PCR micorplates according to the present invention and standard PCR microplates. Lane 1: 100 bp ladder; lanes 2, 3 and 4: 1.25 μl reaction mix in double rimmed small volume PCR micorplates according to the present invention; lanes 5, 6 and 7: 1.25 μl reaction mix in standard PCR microplates, Lane 8; 100 bp ladder.

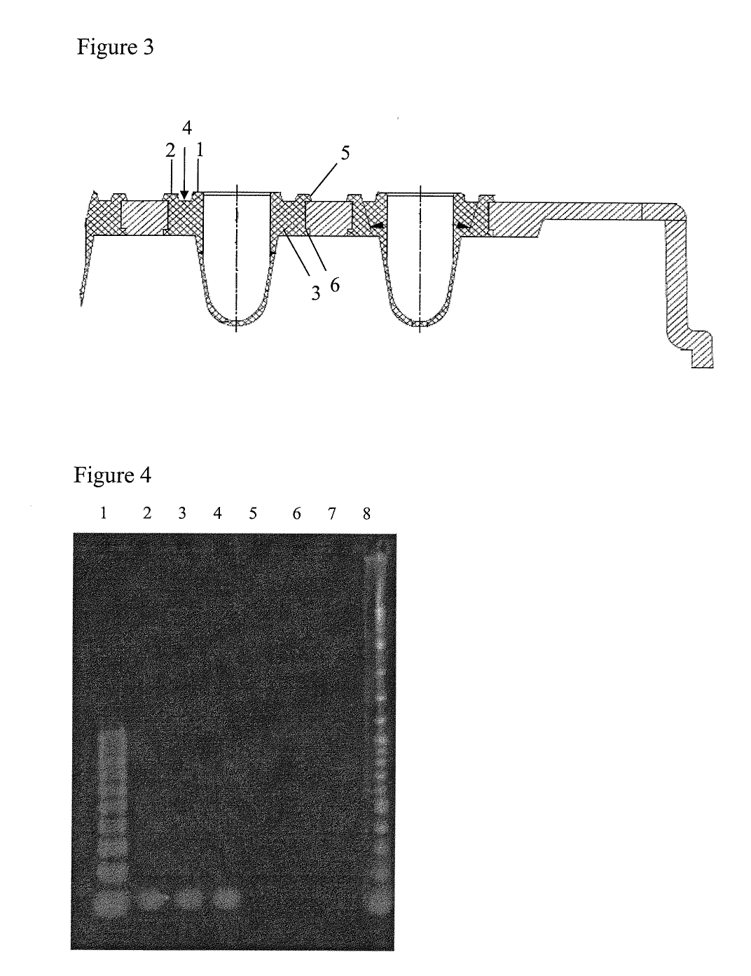

### DETAILED DESCRIPTION OF THE INVENTION

Depending on the material and consistency of the mat, adhesive film or heat seal it may be desirable to have different shapes and/or arrangements of the at least two rims (1; 2). It has been unexpectedly found by the inventors that wells with two rims, wherein the inner rim (1) is higher than the outer rim (2), have astonishingly good properties with respect to the sealing of the wells with adhesive films or heat seals. Hence, in one embodiment of the invention the inner rim (1) is higher than the outer rim (2). However, in a further embodiment the inner rim (1) and the outer rim (2) are of the same height. In yet a further embodiment the outer rim (2) is higher than the inner rim (1).

The difference of height between the at least two rims may be selected according to the respective needs. However, in a preferred embodiment of the present invention the inner rim (1) is 0.05 mm to 1 mm higher than the outer rim (2), preferably the inner rim (1) is 0.1 mm to 1.5 mm higher than the outer rim (2). In a special embodiment the inner rim (1) is 0.1 mm higher than the outer rim (2).

In a further embodiment of the present invention the outer rim (2) is 0.05 mm to 1 mm higher than the inner rim (1), preferably the outer rim (2) is 0.1 mm to 1.5 mm higher than the inner rim (1). In a special embodiment the outer rim (2) is 0.1 mm higher than the inner rim (1).

The skilled artisan may vary the breadth of the rims and/or the gap (4) between the rims (1; 2) in accordance with the needs. In one embodiment the gap (4) has a breadth of 0.1 mm to 2 mm, preferably 0.2 mm to 1 mm, more preferably 0.6 mm to 0.7 mm.

The breadth of the rims may be varied according to the needs. The two rims may have the same breadth or they may differ in their breadths. In a preferred embodiment of the present invention the rims have a breadth of between 0.1 mm and 4 mm, preferably of between 0.4 mm and 1.0 mm, more preferably of between 0.6 mm and 0.85 mm. In a preferred embodiment the inner rim has a breadth of 0.6 mm and the outer rim has a breadth of 0.85 mm.

The skilled artisan is able to chose the form of the at least two rims according to the needs. For example the rims may have a flat upper edge, a rounded upper edge, a sharp upper edge.

It will also be appreciated by the skilled person that the inner rim (1) and the outer rim (2) do not necessarily have to have the same shape. However, in a preferred embodiment the inner rim (1) and the outer rim (2) have a flat upper edge. A preferred flat shape is depicted in the enclosed Figures. However, the scope of the present invention shall not be limited to the embodiment disclosed. The flat upper edge of the rims in one embodiment have a breadth of between 0.1 mm and 4 mm, preferably 0.4 mm to 1.0 mm, more preferably 0.6 mm to 0.85 mm. In a preferred embodiment the inner rim has a breadth of 0.6 mm and the outer rim has a breadth of 0.85 mm.

Furthermore, the skilled artisan is able to decide on the height of the rims in accordance with the needs. However, in one embodiment the rims have a height of 0.1 mm to 2 mm, preferably 0.2 mm to 1 mm, even more preferably 0.4 mm to 0.5 mm In a very special embodiment the inner rim (1) has a height of 0.5 mm and the outer rim (2) has a height of 0.4 mm. The height on the rim may also depend on the arrays and sizes of wells used. For example, in cases where a 24-well microplate or multiwell strips corresponding to the wells size of such plates are used, in a preferred embodiment the rims have a height of about 1.5 mm.

In a preferred embodiment the rim with the greater height has a breadth of up to 0.1 mm less than the rim with the lower height.

“Height of the rims” herein means the height measured from the bottom of the gap (4) to the top of the rim (1;2).

In one preferred embodiment of the present invention the microplate or multiwell strip is a one component microplate or multiwell strip, respectively, i.e. the wells are integral with the frame.

In another preferred embodiment the microplate or multiwell strip is a two component microplate or multiwell strip, respectively, wherein the frame of the microplate or multiwell strip consists of a first material and the wells consist of a second material. Two component microplates are known to those skilled in the art and are disclosed in the prior art; e.g. see WO-A2 01/007160. The materials of the microplate or the multiwell strip may vary and can be adapted to the needs, e.g. thermal resistant, thermal diffusivity or rigidity of the material. For example the first material may selected from the group comprising amorphous plastic partially crystallizing, polycarbonate (PC), cycloolefin copolymer (COC; Topas™ COC), acrylonitrile butadiene styrene (ABS), acetyl copolymer (Delrin), nylon, filled polymers, glass filled polymers, talc filled polymer, cycloolefin polymer (COP). The second material may be for example selected from the group comprising of polypropylene (PP), polyethylene (PE) and polycarbonate (PC). The skilled artisan will recognize that any combinations of first and second material can be used according to the needs and the purposed use of the microplate or multiwell strip. However, in a preferred embodiment of the present invention the first material is polycarbonate (PC) and the second material is polypropylene (PP). In a further preferred embodiment the first material is cycloolefin copolymer (COC; Topas™ COC) and the second material is polypropylene (PP), and in a further preferred embodiment the first material is cycloolefin polymer (COP) and the second material is polypropylene (PP).

In a two component microplate or multiwell strip according to the present invention the collar can be integral with the frame or with the wells. In one embodiment of the present invention the collar is integral with the frame of the two component microplate or multiwell strip. In a preferred embodiment the collar is integral with the wells.

In a two component microplate or multiwell strip the wells have to be fitted into the frame. The inventors found that a collar which extends downwardly and forms a cylinder (3) astonishingly stabilises the wells within the frame of the microplate or multiwell strip. Thus, in one embodiment of the present invention the collar extends downwardly and forms a cylinder (3). In the case of one component microplates or multiwell strips cylinders are not be necessary to stabilize the wells.

It has further been found by the inventors that the fixation of the wells within the frame of the two component microplate or multiwell strip is facilitated by an edge that holds the well in its vertical position in the frame. Hence, in a preferred embodiment of the present invention the cylinder (3) comprises a radial outwardly extending circumferential rim at its upper edge (5). The fixation of the well in its vertical position within the frame may further be enhanced by the provision of a further outwardly extending rim at the lower edge (6) of the cylinder (3). Thus, in a further preferred embodiment the cylinder (3) comprises a radial outwardly extending circumferential rim at its lower edge (6).

It is desirable that the wells are fixed within the frame of the microplate or multiwell strip.

Therefore, the wells may be fitted into the holes of the frame so that essentially no gap (4) is formed between the wells, e.g. the cylinder (3), and the frame, i.e. the wells are positively fitted into the frame. Hence, in one embodiment of the present invention the collars of the wells are positively fitted into the frame of the microplate or multiwell strip. In a preferred embodiment of the invention the cylinder (3) formed by the collar of the wells is positively fitted into the frame of the microplate or multiwell strip.

The skilled person will recognize that the advantages provided by the present invention are not limited to a specific format of wells and strips. Nevertheless, in one embodiment the microplate and multiwell strip according to the present invention are designed for the use in common systems. The commonly used systems have standard dimensions for the measurements of multiwell strips with respect to e.g. the distance between the wells, the dimensions or design of the wells. The skilled person is aware of the standards, e.g. ANSI/SBS 4-2004, “Microplates—Well Position” (http://www.sbsonline.com/msdc/pdf/ANSI_SBS_{—}4-2004.pdf). The standards govern various characteristics of a microplate including well dimensions (e.g. diameter, spacing and depth). Thus, in a preferred embodiment the spacing of the wells meet(s) the standards of ANSI/SBS 1-2004 through ANSI/SBS 4-2004. In a further preferred embodiment the spacing of one well to another with respect to the centre of the wells is selected from the group consisting of 9 mm, 4.5 mm and 2.25 mm.

In a preferred embodiment of the present invention, the microplate comprises 6 to 1536 wells, preferably 6 to 384 wells. In a further preferred embodiment the microplate according to the present invention has 96 wells. In yet a further preferred embodiment of the microplate according to the present invention the spacing of the well positions is the spacing according to the spacing for 96-well microplates as set out in ANSI/SBS 4-2004 and wells with a total volume of 50 μL. In a particularly preferred embodiment the wells have a total height of about 7.35±0.1 mm and a maximum inner diameter of about 3.25 ±0.1 mm.

All the features of the wells, rims and materials of the microplate or multiwell strip according to the present invention as outlined herein shall apply to both, the microplate and the multiwell strips. However, it will be acknowledged by those with ordinary skills in the art that a multiwell strip has a linear array pattern of the wells while the array pattern of microplates is a two dimensional pattern. Hence, in a preferred embodiment of the present invention, the multiwell strip comprises 2 to 64 wells, preferably 4 to 32 wells, more preferably 6 to 8 wells. In a further preferred embodiment of the present invention the spacing of the well positions corresponds to microplates as set out in ANSI/SBS 4-2004 and wells with a total volume of 50 μL. In a particularly preferred embodiment the wells have a total height of about 7.35±0.1 mm and an maximal inner diameter of about 3.25 ±0.1 mm.

It will be acknowledged by those with ordinary skills in the art that the microplate and/or multiwell strips according to the present invention can be used in different laboratory applications. For example, the multiwell strip or microplate may be used for storage of compounds or samples or may be used in research procedures and/or diagnostic techniques. Hence, the present invention also relates to the use of a microplate or a multiwell strip according to the present invention in research procedures and diagnostic techniques. In a preferred embodiment of the present invention the research procedure and/or diagnostic technique is selected from the group consisting of amplification of nucleic acids, polymerase chain reaction (PCR) based methods, ELISA, sequencing, high content screening, crystallography, melt curve determination, hybridisation related assays, in vitro translation, in vitro transcription, cell-culturing.

It has been unexpectedly found by the inventors that, due to their surprising properties, the microplate and multiwell strips of the present invention are extraordinary well suited for storage of compounds or samples. Due to the complete sealing the integrity of compounds and samples is maintained over a longer period when compared to microplates, multiwell strips or other storage devices of prior art. Hence the present invention also relates to the use of the microplate and multiwell strips according to the present invention for storage of samples, storage of compounds.

The term “sample” as used herein refers to any kind of substance or substance mixture to be analysed. A sample in the meaning of the invention may be a sample originating from an environmental source, such as a plant sample, a water sample, a soil sample, or may be originating from a household or industrial source or may also be a food or beverage sample.

A sample in the meaning of the invention may also be a sample originating from a biochemical or chemical reaction or a sample originating from a pharmaceutical, chemical, or biochemical composition. A sample may also be a forensic or medical sample such as bodily fluids or tissue samples.

### EXAMPLE 1

Comparison of liquid loss between plates of prior art and double rimmed plates according to the present invention.

Three types of plates where compared (3 plates each (triplicate)):

1. Microplate with standard single raised rim around each well (4titude, No. 4ti-0750)

2. Two component microplate (Framestar) with standard single raised rim around each well (4titude, No. 4ti-0710)

3. A double rimmed microplate according to the present invention (see Figures)

Each of the 96 wells of the 3 plate types were filled with 10 μL H₂O. The microplates were then heat sealed using heat sealing sheets, clear weld seal, (4titude, No. 4ti-0575), Thereafter the plates were weighed (Mettler Toledo scales). The plates where then heated and cooled in 30 cycles using a standard thermal cycler (Thermo, PX2 thermal cycler): 30 seconds at 95° C. and 30 seconds 55° C. The microplates were weighed after the cycling procedure and the loss of H₂O per plate was calculated:

Results:

Average weight loss:

1. Standard microplate=103 μL

2. FrameStar microplate=95 μL

3. Double rimmed microplate=75 μL

By using a microplate according to the present invention it is possible to greatly reduce evaporation of liquids from the wells of the microplate. Unexpectedly the double rimmed microplate according to the present invention showed a 27 to 21% reduced evaporation rate when compared to the standard and framestar microplate, respectively. This effect can be further enhanced by longer heating and/or increasing of the cycle number. The use of adhesive films for sealing the plates resulted in a yet further enhancement of the effect.

### EXAMPLE 2

Double rimmed small volume PCR microplates and standard PCR microplates low volume comparison study.

In order to show the comparison between double rimmed small volume (50 μL total volume for each well) PCR microplates in the 96-well format according to the present invention and standard PCR microplates in the 384 well format (49.5 μL total volume for each well) a small volume comparison was set up. A GAPDH reaction mix (Solaris) was prepared according to the manufacture's instructions and 1.25 μl aliquots were transferred into small volume PCR microplates according to the present invention and standard PCR microplates as triplicates for both. The plates were sealed using heat sealing sheets, clear weld seal, (4titude, No. 4ti-0575). The reactions were performed under standard PCR conditions in parallel.

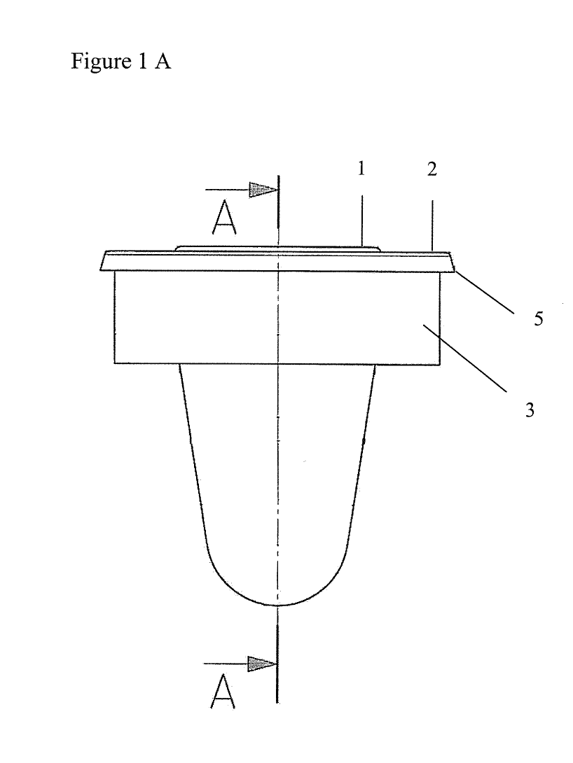

Afterwards, the reaction mixture was loaded onto a 1.5% agarose gel, the result of which can be found at FIG. 1. Lanes 2, 3 and 4 show a distinct amplification product with the expected size as compared to the ladder in lane 1. In lanes 4, 5 and 6 no amplification product was detectable. These results clearly show that the double rimmed microplate by its good sealing properties allows amplification of nucleic acids in very small reaction volumes.

1. A microplate, wherein the openings of the well for receiving reagents have a collar, wherein the collar comprises at least two upwardly extending rims, wherein the rims are radially separated by a gap (4), and wherein the rims are circumferentially closed.

2. The microplate according to claim 1, wherein the inner rim (1) is higher than the outer rim (2).

3. The microplate according to claim 1, wherein the microplate is a two component microplate, and wherein the frame of the microplate consists of a first material and the wells consist of a second material.

4. The micropate according to claim 3, wherein the collar is integral with the wells.

5. The microplate according to claim 4, wherein the collar extends downwardly and forms a cylinder (3).

6. The microplate according to claim 5, wherein the cylinder (3) comprises a radial outwardly extending circumferential rim at its outer edge (5).

7. The microplate according to claim 6, wherein the cylinder (3) comprises a radial outwardly extending circumferential rim at its lower edge (6).

8. The microplate according to claim 7, wherein the collars of the wells are positively fitted into the frame of the microplate.

9. The microplate according to claim 8, wherein the microplate comprises 6 to 1536 wells, preferably 6 to 384 wells.

10. The microplate according to claim 9, wherein the microplate comprises 96 wells.

11. A multiwell strip, wherein the openings for receiving reagents of the wells have a collar, wherein the collar comprises at least two upwardly extending rims, wherein the rims are radially separated by a gap (4), and wherein the rims are circumferentially closed.

12. The multiwell strip according to claim 11, wherein the inner rim (1) is higher than the outer rim (2).

13. The multiwell strip according to claim 12, wherein the multiwell strip is a two component multiwell strip, and wherein the frame of the multiwell strip consists of a first material and the wells consist of a second material.

14. The multiwell strip according to claim 13, wherein the collar is integral with the wells.

15. The multiwell strip according to claim 14, wherein the collar extends downwardly and forms a cylinder (3).

16. The multiwell strip according to claim 15, wherein the cylinder (3) comprises a radial outwardly extending circumferential rim at its upper edge (5).

17. The multiwell strip according to claim 16, wherein the cylinder (3) comprises a radial outwardly extending circumferential rim at its lower edge (6).

18. The multiwell strip according to claim 17, wherein the collars of the wells are positively fitted into the frame of the multiwell strip.

19. The multiwell strip according to claim 18, wherein the multiwell strip comprises 2 to 64 wells, preferably 4 to 32 wells, more preferably 6 to 8 wells.

20. Use of a microplate according to claim 1 in research procedures and diagnostic techniques.

21. The use according to claim 20, wherein the research procedure and/or diagnostic technique is selected from the group consisting of amplification of nucleic acids, polymerase chain reaction (PCR) based methods, ELISA, sequencing, high content screening, crystallography, melt curve determination, hybridisation related assays, in vitro translation, in vitro transcription, cell-culturing, storage of samples, storage of compounds.
